(19) United States
(12) Patent Application Publication
(10) Pub. No.: US 2002/0093161 A1
(43) Pub. Date: Jul. 18, 2002

(54) Scooter

(75) Inventors: Steven C. Udwin, Tenafly, NJ (US); David Tarica, Tenafly, NJ (US); Marshall L. Weingarden, Haworth, NJ (US)

Correspondence Address: WEINGRAM & ASSOCIATES, P.C., P.O. BOX 927, 197 WEST SPRING VALLEY AVE., MAYWOOD,, NJ, 07607, US

(73) Assignee: ENOR CORPORATION

(21) Appl. No.: 09/760,501

(22) Filed: Jan. 12, 2001

(51) Int. Cl. B62M 1/00

(52) U.S. Cl. 280/87.05; 280/639

(57) ABSTRACT

A rider propelled lightweight collapsible scooter includes a collapsible mechanism with a front vertical assembly including a vertical riser tube, handle and front wheel pivotable from a vertical operational position to a horizontal storage/transport position. The vertical riser tube and handle are adjustable to the height of the user and can be telescoped to a smaller size. A spring biased collar on a pivot tube coacts with a positioning post on a rider platform to provide positively locked vertical and horizontal positions when moving from the operating to the collapsed position.

### BACKGROUND OF THE INVENTION

1. Field of the Invention

The present invention relates to a rider propelled lightweight collapsible scooter and more particularly, to a scooter which has a relatively simple structure that can be easily and safely collapsed and folded for carrying or storing. The scooter has no hazardous mechanisms that can cause injuries to the users, especially young children.

2. Description of the Prior Art

Two wheel light weight foot propelled scooters have long been a popular play thing that provides utility as a limited transportation vehicle for children as well as adults. The recent popularity of collapsible scooters has brought certain problems related to safety, especially when these devices are used by children. Many children have received painful and often serious hand and finger injuries due to hazards associated with the mechanism that collapses the vertical riser tube and handle portions of the scooter. Examples of known collapsible type scooters are shown in the following patents.

U.S. Pat. No. 4,842,091 to Badsey discloses a two wheeled motor driven scooter having a steering shaft and handle that are folded onto the platform for storage or transportation.

U.S. Pat. No. 5,183,129 to Powell discloses a motor driven two wheeled collapsible scooter wherein the front frame, steering column and handle bar pivot to a collapsed position.

U.S. Pat. No. 5,265,695 to Piazzi discloses a two-wheeled collapsible motorized golf cart having two parallel support bases for the users feet with a golf club container pivoting forward over the bases and an upper steering column and handle bar pivoting rearward over the golf club container into a storage position.

U.S. Pat. No. 5,388,659 to Pepe discloses a motorized two wheeled scooter having a motor mounted on the frame adjacent the rear wheel, a rider supporting deck on the frame between the front and rear wheels, and a folding steering member which folds down over the deck and latches onto a rear portion to serve as a carrying handle.

U.S. Pat. No. 5,848,660 to Mc Green discloses a lightweight collapsible two wheeled scooter having a steering assembly and handle bar pivotally secured to the front of a frame with the front wheel secured to the steering assembly. A hydraulic gas spring strut pivotally secures the steering assembly to the frame. The strut in an extending position locks the steering assembly in an upright position for operation by a rider. When in a compressed position, the strut assembly locks the steering assembly handle and front wheel in a collapsed position parallel to and adjacent the frame assembly for storage or transportation.

U.S. Pat. No. 5,927,733 to Banda discloses a folding two wheel scooter having a pair of tubular support frames connected between a forward vertical support member for a front yoke and wheel and a rearward yoke supporting a rear wheel. A stepping platform is mounted on the tubular supports between front and rear wheels. A pivotable vertical steering assembly is secured to the forward vertical support when in use and is pivoted to a horizontal position when the scooter is folded. A securing bracket on a mudguard-brake over the rear wheel holds the vertical steering assembly. Hinged levers and a brake pad between the mudguard and rear yoke stop the scooter when stepping on the mudguard.

U.S. Pat. No. 6,012,539 to Patmont discloses to a two wheeled motorized scooter having a tubular chassis with a rear mounted motor. A spring biased reciprocating sleeve fits over a hinge connecting a lower vertical base of a steering handle to the upper tubular steering handle. When the sleeve is moved upwardly, the steering handle can be folded to a horizontal position to reduce size for transportation.

These prior art collapsible scooter mechanisms are relatively complex and have presented problems concerning safety when operated by children.

### OBJECTS AND SUMMARY OF THE INVENTION

It is therefore the primary object of the present invention to provide a collapsible scooter having a relatively simple and safe construction.

It is another object of the invention to provide a scooter having a collapsible front riser and handle which is easy to use and change from one position to another.

It is a further object of the invention to provide a collapsible scooter having a front vertical riser tube that is adjustable in height and can be telescoped to a relatively small size.

A still further object of the invention is to provide a scooter which is firmly secured in either an operative or collapsed position without removal of any parts.

Yet another object of the invention is to provide a collapsible scooter which is free of hazardous openings or positions that can trap fingers or hands.

An additional object of the invention is to provide a scooter having a front riser tube which is positively locked in either the operative vertical or collapsed horizontal positions.

It is also an object of the present invention to provide a scooter which is quickly collapsible without requiring any special tools to operate or adjust from one position to another.

An added object of the invention is to provide a collapsible scooter wherein the vertical riser tube can be moved to a horizontal position without changing the height adjustment of the tube.

These objects are achieved with a novel collapsible scooter mechanism wherein the entire front assembly of vertical riser tube, handle and front wheel is pivotable between a vertical and horizontal position. The front vertical riser and hand grips are also adjustable to the height of the user and can be telescoped to a relatively small size. A biased collar on a pivot tube coacts with a specifically shaped positioning post to provide positively locked vertical and horizontal positions. The coaction enabled by the shape of the positioning post with the biased collar presents no openings or positions in which a finger or other body member can be trapped during the operation of the device when moving between the operative vertical position to the collapsed horizontal state.

Other objects and advantages will become apparent from the following description taken in conjunction with the accompanying drawings.

### BRIEF DESCRIPTION OF THE DRAWINGS

FIG. 1 is a perspective view of the entire scooter in an upright position.

FIG. 2 is a perspective view of the scooter in an upright position with the upper vertical post collapsed into the lower front vertical riser tube and the handle grips in the pivoted storage position.

FIG. 3 is a perspective view of the scooter in a fully collapsed position ready for storage.

FIG. 4 is a perspective view of the front lower portion of the scooter showing the locking mechanism with the spring and collar holding the support and pivot tubes in an upright locked position.

FIG. 5 is a perspective view of the front lower portion of the scooter showing the locking mechanism with the spring compressed by the collar and awaiting release from the positioning post.

FIG. 6 is a perspective view of the front lower portion of the scooter with the locking mechanism holding the support and pivot tubes in the horizontal locked position ready for storage.

FIG. 7 is a sectional view of the locking mechanism with the spring and collar holding the support and pivot tubes in an upright locked position.

FIG. 8 is a sectional view of the locking mechanism with the spring compressed and dot and dashed lines showing the movement from the upright position to the horizontal storage position.

FIG. 9 is a sectional view of the locking mechanism with the spring and collar locking the support and pivot tubes in the horizontal storage position.

FIG. 10 is a perspective view of the vertical riser with the cam lock arm in the unlocked position ready for sliding the vertical adjustable post into the vertical tube, and the disassembled handled grips released from the horizontal bar ready to take the storage position.

### DETAILED DESCRIPTION OF THE PREFERRED EMBODIMENTS

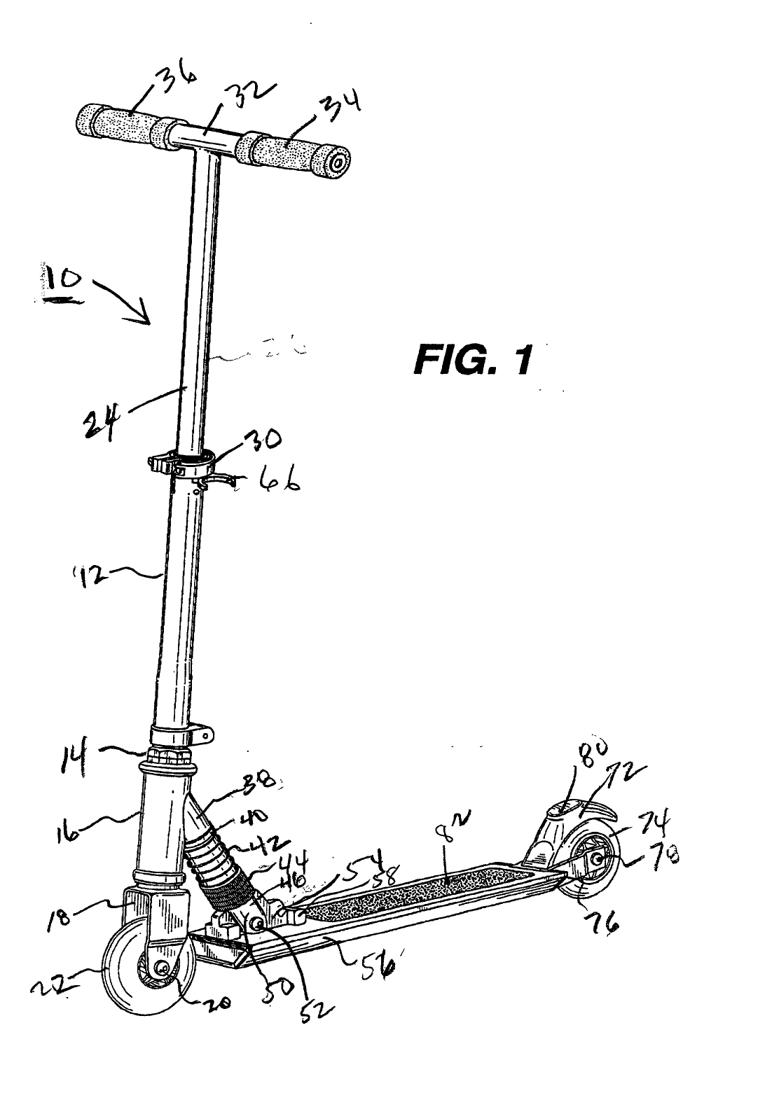

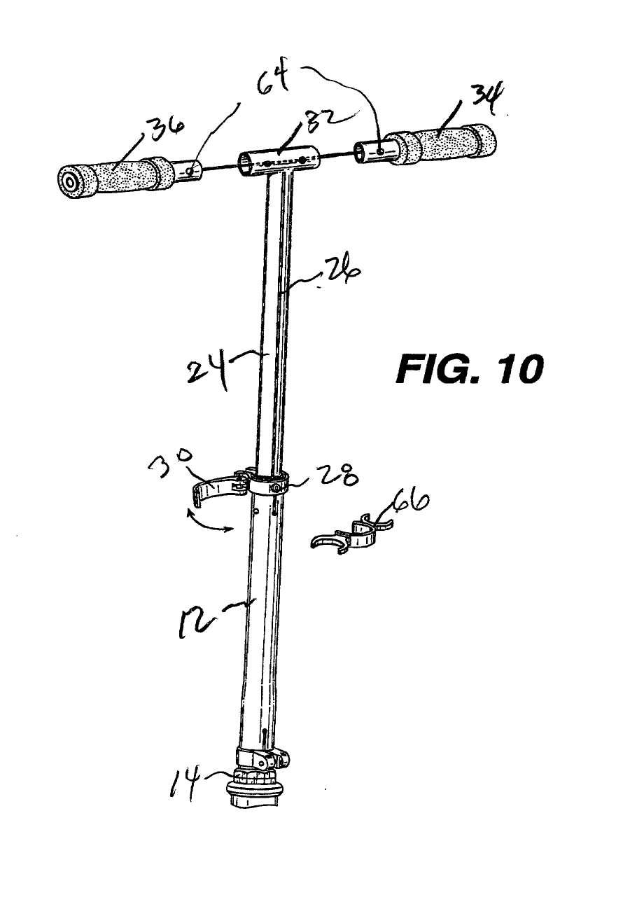

As shown in FIG. 1, the scooter 10, shown generally, includes a front vertical riser tube 12, rotatably secured by head nut 14 to pass thorough vertical head support tube 16 for connection to front fork 18 journalled within tube 16. Axle 20 rotatably secures front wheel 22 to fork 18. An adjustable upper vertical post 24 fits into and slidably engages tube 12. As shown in FIG. 10,post 24 includes a positioning groove 26 which receives positioning screw 28 that is tightened and locked in place by cam lock arm 30 to control the height adjustment of post 24. This secures post 24 at a desired height to meet the height requirements of the individual rider. The upper end of post 24 is attached to a horizontal cross bar 32 coupled to a pair of handle grips 34,36.

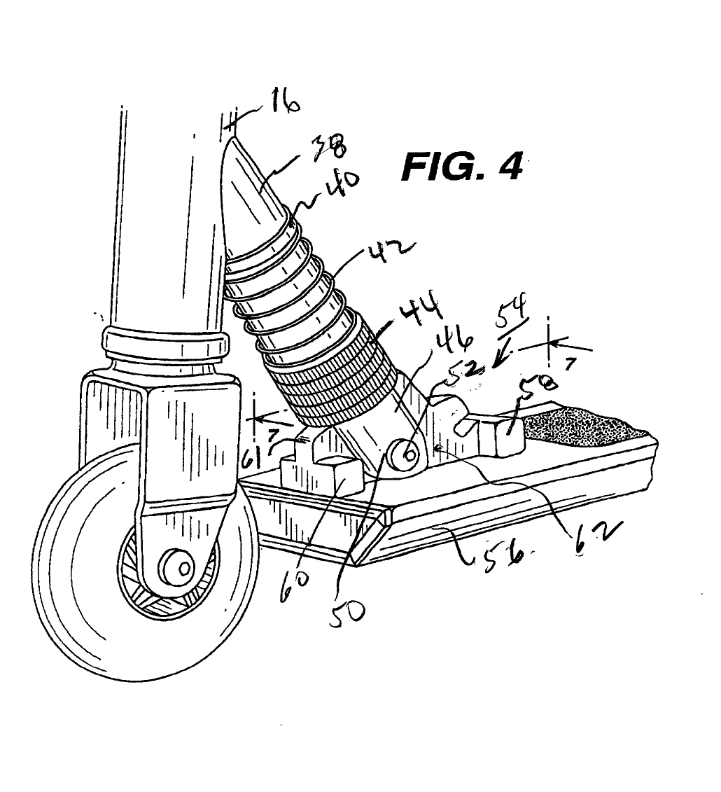

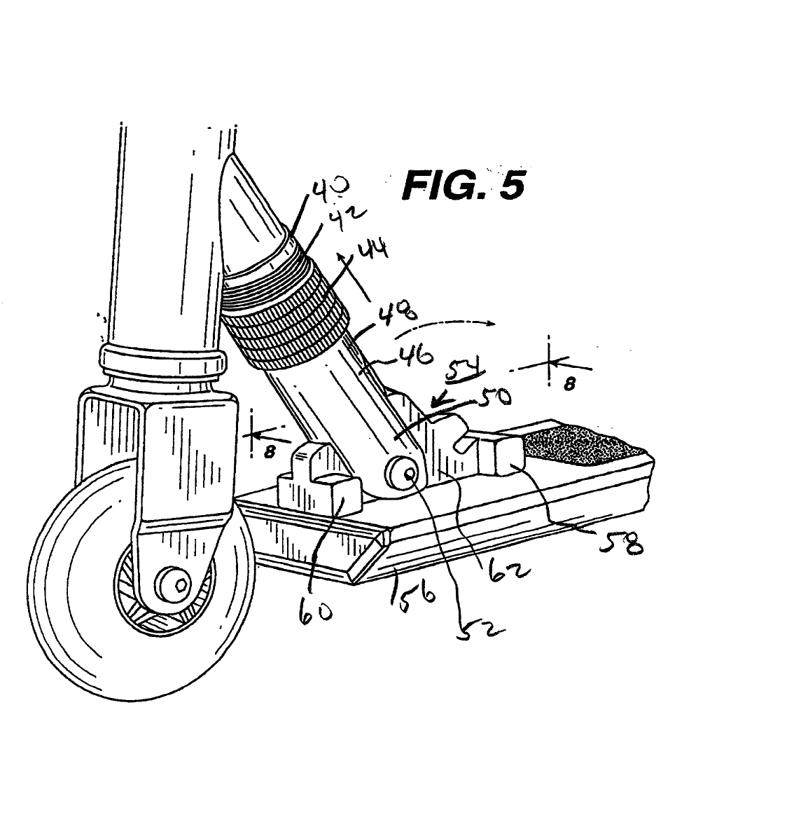

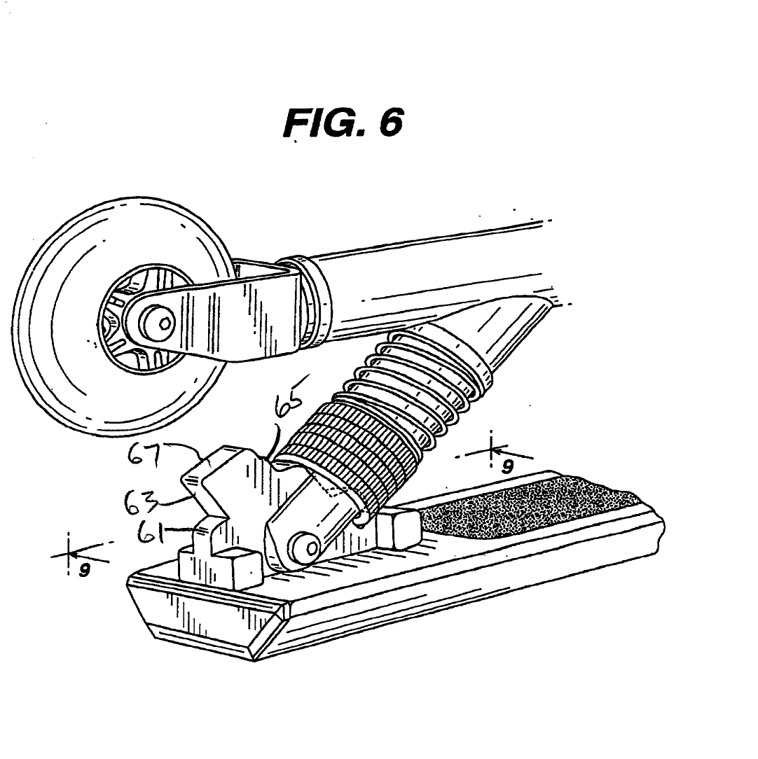

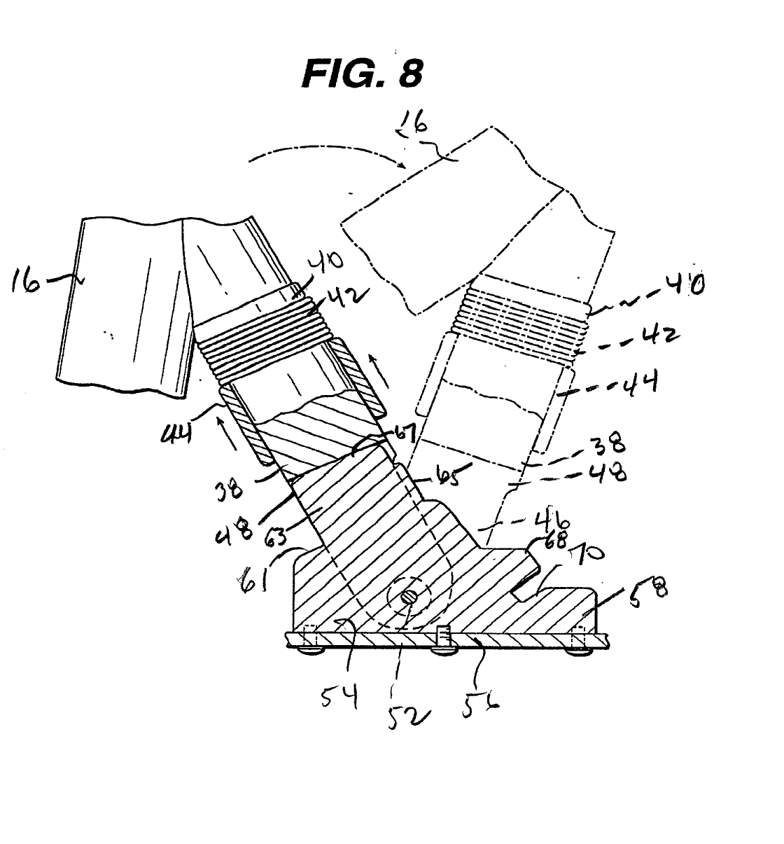

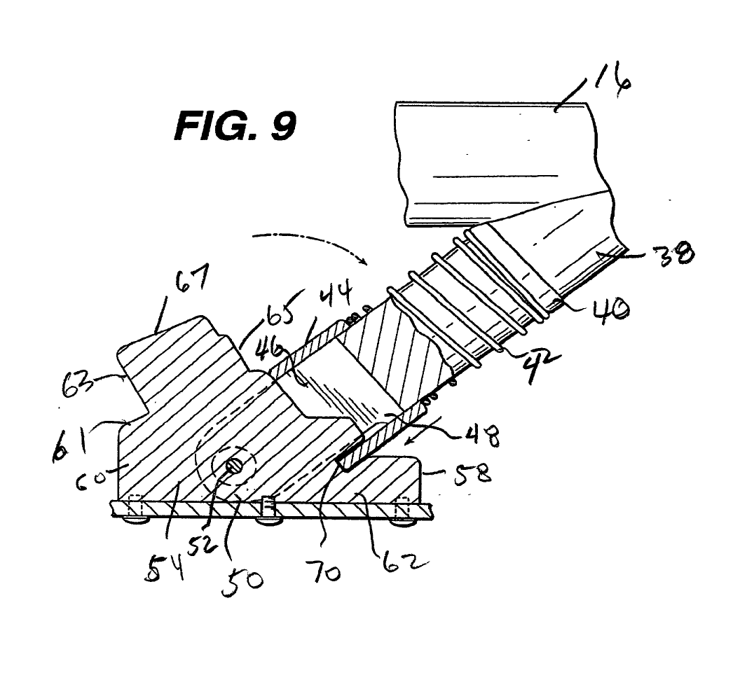

A pivot tube 38 is connected at an angle to lower support tube 16. A spring seat ⁴⁰, shown more clearly in FIG. 4, is secured to pivot tube 38 and a spring 42 is positioned around tube 38 between seat 40 and a collar 44. As shown FIGS. 5-9, collar 44 encloses the lower end of pivot tube 38 which abuts and is affixed to a positioning fork 46 having an upper barrel 48 and a finger 50 secured by an axle 52 to a positioning post 54 which is mounted and secured on platform 56. Post 54 includes rear stabilizing legs 58, front stabilizing legs 60 and a center body 62.

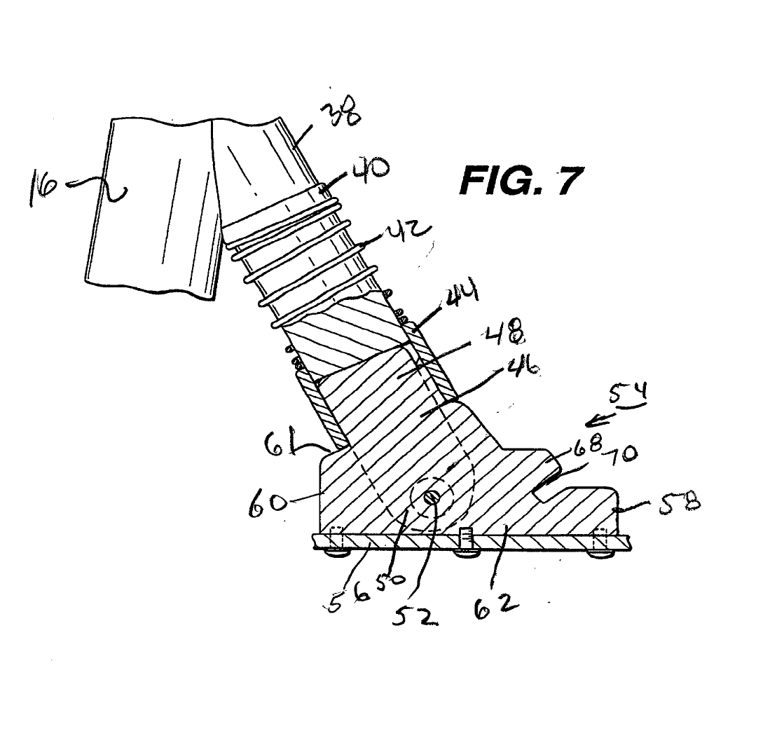

As shown in FIGS. 4,7,8 and 9, spring 42 normally applies force against collar 44 to lock fork 46 in the upright position on positioning post 54 against front shoulder 61, front positioning post 63, front locking spine 65 and engaging end 67. This maintains the vertical position of components. FIGS. 4 and 7 show the pivot tube 38 and positioning fork 46 secured on positioning post 54 in the forward position to hold the vertical riser tube 12 in an upright position during normal operation of the scooter.

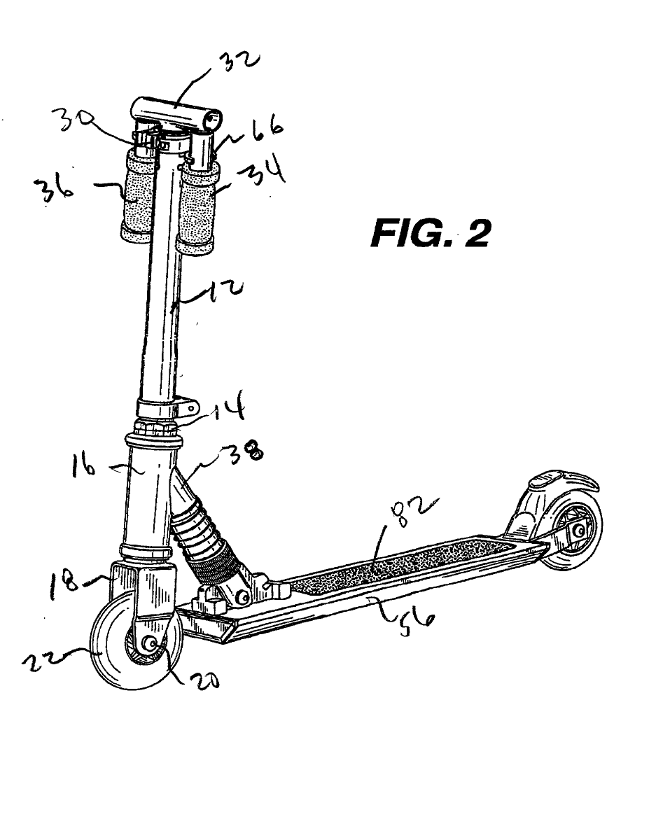

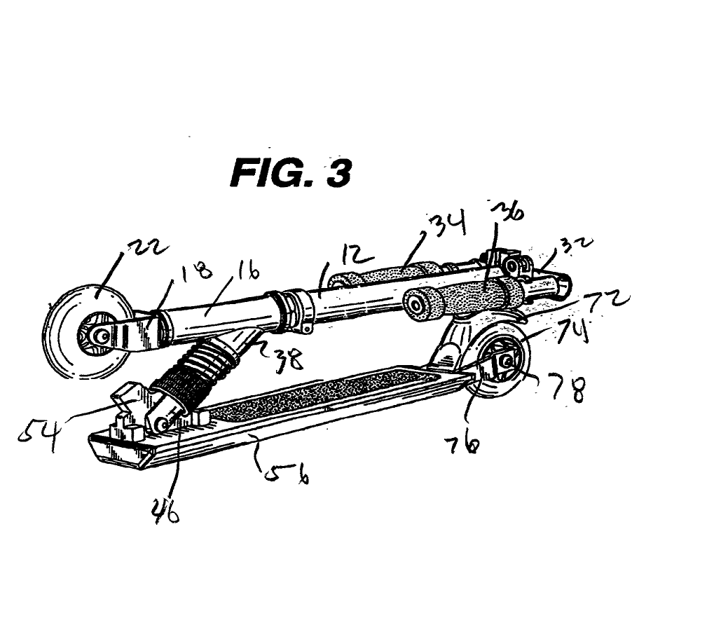

In order to change the position of the scooter from the vertical operative condition of FIG. 1 to the collapsed folded position as in FIG. 3, several steps are necessary. As shown in FIGS. 10 and 2, handles 34, 36 are released from engagement with holes in horizontal bar 32 by pressing release buttons 64. Adjustable vertical post 24 is released by loosening positioning screw 28 and sliding post 24 down into vertical riser tube 12. If desired, the adjusted length of post 24 may remain as set when folded in the collapsed position. Handles 34 36 are placed in hand grip holders 66 and secured along with post 24 to tube 12 by cam lock arm 30.

As shown in FIGS. 5,6,8 and 9, the entire vertical structure is then collapsed into a horizontal position. Collar 44 is moved up along positioning fork barrel 48 and pivot tube 38 to compress spring 42 against spring seat 40. Positioning fork 46 and finger 50 are then pivoted backward along positioning post 54 until collar 44 is moved down by spring 42 over rear positioning post 68 into engagement with rear locking notch 70. In this final collapsed position, as shown in FIGS. 3,6 and 9, the entire vertical assembly including wheel 22, front fork 18, lower tube 16, riser tube 12, handle bars 34, 36 and upper bar 32 are locked in a horizontal position, while being connected by pivot tube 38 and positioning fork 46 to positioning post 54 secured to the front end of platform 56. The upper end of tube 12, bar 32 and handles now rest on a spring mounted rear fender 72 attached to the back end of platform 56.

The fender 72 is positioned over the rear wheel 74 with a rear fork 76 connected between the rear of platform 56 and axle 78 to support the rear platform end. A step 80 on the top of fender 72 permits the rider to apply foot pressure to depress the fender to contact wheel 74 and act as a brake for gradually slowing and stopping the scooter when in use.

The platform 56 is preferably of a single aluminum extrusion with the rear fork welded or bolted to the inside edges of the extrusion so that there are no sharp edges exposed. The platform has a skid resistant layer 82 on the upper surface to provide traction for the rider. The relatively simple mechanism and structure for operating and collapsing the scooter provides safety features which avoid intricate shapes and devices that can cause injuries.

It will be understood that the embodiments described herein are merely exemplary and that a person skilled in the art may make many variations and modifications without departing from the spirit and scope of the invention. All such variations and modifications are intended to be included in the scope of the invention as defined in the appended claims.

What is claimed is:

1. A scooter, comprising:
a generally vertical column,
a vertical support tube rotatably receiving the lower end of said column,
a front wheel rotatably secured to said lower end of said column within said support tube,
an upper vertical bar slidable within the upper end of of said column and being adjustable in height,
a handle bar connected crosswise to the upper end of said upper vertical bar,
a lower riding platform,
a rear wheel rotatably secured to the back end of said platform,
mounting means secured on the front end of platform, and
pivot means connected between said vertical support tube and said mounting means and being engageable with said mounting means in a first locking position maintaining said vertical support tube and column in a generally vertical operational position and being pivotable into engagement with said mounting means in a second locking position maintaining said support tube and column in a generally horizontal collapsed folded position.

2. The scooter of claim 1, wherein said pivot means includes:
a pivot tube and positioning fork having one end pivotally engaging said mounting means,
a manually operable spring biased control means secured and movable on said pivot tube,
said mounting means having projections engageable with said pivot tube and positioning fork and control means in said first and second positions and having a locking notch engageable with said control means in said second position,
operation of said control means permitting release of said pivot tube and positioning fork from one locking position on said mounting means and permitting movement into the second locking position.

3. The scooter of claim 2, wherein said control means includes a collar and spring moveable along said pivot tube.

4. The scooter of claim 3, wherein said upper vertical bar includes a vertical slot, and said vertical column includes a screw engageable with said slot for adjusting said height.

5. The scooter of claim 4, further including a cam lock mounted on the upper end of said column for locking said slidable upper vertical bar within said column.

6. The scooter of claim 4, wherein said handle bar includes handle grips secured at each end and means for releasing said grips from each end.

7. The scooter of claim 6, further including handle grip holders mounted on the upper end of said column for securing said handle grips upon release from each end.

8. The scooter of claim 4, further including a front fork securing said front wheel to said lower end of said column and a rear fork securing said rear wheel to said back end of said platform.

9. The scooter of claim 8, further including a fender flexibly secured to the back end of said platform over said rear wheel and including brake means secured within the fender whereby pressure upon said fender applies said brake means to said rear wheel.

10. The scooter of claim 9, wherein said fender includes a step on the upper surface for applying foot pressure of a rider on said fender, said upper end of said vertical column resting upon said upper fender surface in the folded collapsed position.

11. A scooter, comprising:
a generally tubular vertical column,
a vertical support tube rotatably receiving the lower end of said column,
a front wheel supporting fork rotatably secured to said lower end of said column within said support tube,
a front wheel secured to an axle rotatably secured to said front wheel fork,
an upper vertical bar slidable within the upper end of said column and including a longitudinal slot providing a height adjustment,
a screw mounted at the upper end of said column for engagement with said slot for adjusting the height of said upper bar,
a handle bar connected crosswise to the upper end of said upper vertical bar and including detachable handle grips at each handle bar end,
a lower riding platform,
a rear wheel supporting fork secured to the back end of said platform,
a rear wheel rotatably secured to said rear wheel fork,
a positioning post mounted on the front end of said platform,
a pivot tube connected between said vertical support tube and said positioning post, said pivot tube including a positioning fork having one end pivotally engaging said positioning post, and
a manually operable spring biased collar secured and movable on said pivot tube,
said positioning post having projections engageable with said pivot tube and positioning fork and collar and having a locking notch engageable with said collar,
said projections and notch providing first and second locking positions maintaining said vertical support tube and column in a first generally vertical operational position and maintaining said support tube and column in a second generally horizontal collapsed position upon movement of said collar and pivot tube and positioning fork between said first and second positions on said positioning post.
